(19) United States
(12) Patent Application Publication
(10) Pub. No.: US 2022/0331620 A1
(43) Pub. Date: Oct. 20, 2022

(54) FACE MASK

(71) Applicant: KONINKLIJKE PHILIPS N.V., EINDHOVEN (NL)

(72) Inventors: Wei GU, SHANGHAI (CN); Feng QIN, SHANGHAI (CN); Qiushi ZHANG, SHANGHAI (CN); Ruben Arnold Herman REEKERS, SHANGHAI (CN); Weizhong CHEN, SHANGHAI (CN)

(21) Appl. No.: 17/639,475

(22) PCT Filed: Aug. 28, 2020
(86) PCT No.: PCT/EP2020/074137

§ 371 Date: Mar. 1, 2022

(30) Foreign Application Priority Data
Sep. 4, 2019 (CN) PCT/CN2019/104369
Oct. 15, 2019 (EP) 19203151.6

(51) Int. Cl. A62B 18/00; A62B 18/02

(52) U.S. Cl. CPC A62B 18/006; A62B 18/025

(57) ABSTRACT

A face mask has a centrifugal fan assembly, with a radial outlet outside the mask cavity. A flow adjusting element is added to prevent outlet flow from the fan assembly traveling along the outside of the mask and reaching the user, for example at the neck.

### FIELD OF THE INVENTION

This invention relates to face mask, for providing filtering of pollutants.

### BACKGROUND OF THE INVENTION

Air pollution is a worldwide concern. The World Health Organization (WHO) estimates that 4 million people die from air pollution every year. Part of this problem is the outdoor air quality in cities. Nearly 300 smog-hit cities fail to meet national air quality standards.

Official outdoor air quality standards define particle matter concentration as mass per unit volume (e.g. μg/m³). A particular concern is pollution with particles having a diameter less than 2.5 μm (termed “PM2.5”) as they are able to penetrate into the gas exchange regions of the lung (alveoli), and very small particles (<100 nm) may pass through the lungs to affect other organs.

Since this problem will not improve significantly on a short time scale, a common way to deal with this problem is to wear a mask which provides cleaner air by filtration and the market for masks in China and elsewhere has seen a great surge in recent years.

Such masks may be made of material that acts as a filter of pollutant particles, or may have a filter for only part of the mask surface, and this filter may be replaceable when it becomes clogged.

However, during use, the temperature and relative humidity inside the mask increases and, combined with the pressure difference inside the mask relative to the outside, this makes breathing uncomfortable. This can be mitigated in part by providing an outlet valve or check valve which allows exhaled air to escape the mask with little resistance, but which requires inhaled air to be drawn through the filter. To improve comfort and effectiveness, a fan can be added to the mask, this fan drawing in air through the filter and/or providing assistance when breathing out.

One possible benefit to the wearer of using a fan-powered mask is that the lungs are relieved of the slight strain caused by inhalation against the resistance of the filters in a conventional non-powered mask. Furthermore, in a conventional non-powered mask, inhalation also causes a slight pressure drop within the mask which leads to leakage of the contaminants into the mask, which leakage could prove dangerous if these are toxic substances.

Fan-assisted masks thus may improve the wearing comfort by reducing the temperature, humidity and breathing resistance.

In one arrangement, an inlet (i.e. inhale) fan may be used to provide a continuous intake of air. In this way, the lungs are relieved of the slight strain caused by inhalation against the resistance of the filters in a conventional non-powered mask. A steady stream of air may then be provided to the face and may for example provide a slight positive pressure, to ensure that any leakage is outward rather than inward. However, this gives additional resistance to breathing when exhaling.

In another arrangement, an exhaust (i.e. exhale) fan may be used to provide a continuous release of air. This instead provides breathing assistance when exhaling. An exhale fan may be combined with a series check valve so that no flow can enter the mask through the fan.

The fan again creates a continuous flow of air through the mask. Air is drawn into the mask cavity through the filter by the flow induced by the fan. This improves wearer comfort.

Another alternative is to provide both inlet and exhaust fans, and to time the control of the fans in synchronism with the breathing cycle of the user. The breathing cycle may be measured based on pressure (or differential pressure) measurements. This provides improved control of temperature and humidity as well as reducing the resistance to breathing for both inhalation and exhalation.

Thus, several types of mask for preventing daily exposure to air pollutants are available, including passive masks, passive masks with an exhale valve, and masks with at least one active fan.

This invention relates in particular to active masks, having a fan, and more particularly to designs having at least an exhale fan.

Axial fans may be used. However, these have the problem of a large size, and the exit or entrance opening is clearly visible. It is preferred to make use of a centrifugal fan, having an axial flow on one side and a radial flow on the other side. By arranging the radial flow on the outside of the mask, the radial outlet can be hidden from view, for example it can face down or backwardly.

The invention is based on the recognition that a problem with the use of a centrifugal fan, with the radial outlet outside the mask, is that the outlet flow may track the outer contour of the mask due to the Coanda effect, and hence be directed towards the wearer, for example at the neck or face.

While this flow may be beneficial in summer, the flow against the neck can make the user cold, particularly in winter.

There is therefore a need to address this problem to improve wearing comfort.

### SUMMARY OF THE INVENTION

The invention is defined by the claims.

According to examples in accordance with an aspect of the invention, there is provided a face mask, comprising:

a mask body, wherein a mask cavity is defined inside the mask body when the mask is worn by a user;

a fan assembly mounted on or through the mask body, the fan assembly comprising a centrifugal fan having an axial inlet communicating with the inside of the mask cavity and a radial outlet outside the mask cavity; and

a flow adjustment element, comprising a lip downstream of the radial outlet for directing the flow from the radial outlet away from the mask body.

The use of radial fan outlet at the outside of the mask body means that a flow may be generated along the outside of the mask body. Depending on the orientation of the radial outlet, this flow may reach the user and cause discomfort.

The flow adjustment element disturbs the outlet flow from the fan assembly, in particular to disrupt the Coanda effect. The lip is for example used to introduce a tight radius to the flow path.

The mask body for example comprises opposite lateral sides which are adapted to face at least partially laterally outwardly when the mask is worn by a user, and the fan assembly is mounted at one of the opposite lateral sides.

The mask design with lateral sides, on at least one of which a fan assembly is mounted, is found to be a popular mask design, for example as opposed to a design with the fan assembly in a plane parallel with the general plane of the face of the user.

The mask body may comprise a ridge between the opposite lateral sides. This gives the overall design a V-shaped appearance (in plan view), which is a popular aesthetic design.

When a fan assembly is mounted on a lateral surface, it faces at least partly in the forward-backward direction, so that when a flow is generated along the surface of the mask, this may extend back towards the user.

A second fan assembly may be on the opposite lateral side to the (first) fan assembly. The first fan assembly is an exhaust fan (because the outlet is at the outside of the mask cavity). The second fan assembly may be another exhaust fan, so that the mask weight is balanced, with the fan function shared between two smaller fans. Alternatively, the second fan assembly may be an inlet fan. Thus, the mask may have both inlet and exhaust fans, for example controlled in synchronism with the breathing of the user.

In one set of examples, the mask body comprises a filter member. This gives a low component count. The mask filter member may then comprise an opening for receiving the fan assembly.

In another set of examples, the mask body comprises an outer casing, and the face mask further comprises an inner filter member for mounting inside the outer casing. This provides a protective outer casing, and which may have improved aesthetic appearance than the filter member. The outer casing may then comprise an opening for receiving the fan assembly.

The radial outlet may be adapted to face at least partially backwardly or at least partially downwardly when the face mask is worn by a user. This means the outlet flow may be directed to the face, neck or shoulders of the user.

Note that “forward” in this document is intended to mean in the direction faced by a user wearing the mask, and “backward” is intended to mean in the opposite direction to forward.

In a first set of examples, the lip has a first ramp surface which extends outwardly with increasing distance from the radial outlet, and a second ramp surface downstream of the first ramp surface, which extends inwardly with increasing distance from the radial outlet.

“Outward” is intended to denote a direction normal to the general local area of the mask body, and facing away from the mask cavity.

The outlet flow from the fan thus rises up the first ramp, then reaches an apex. The radius of this apex, which is the junction between the first and second ramp surfaces, is such as to disrupt the flow, and prevent it flowing further along the outer wall of the mask body. Instead, the flow is directed away from the mask body.

The radial outlet has an outward height, and the length of the first ramp surface along the radial outlet flow direction (and projected onto the outer surface of the mask body) is preferably greater than the outward height.

The length of the second ramp surface along the radial outlet flow direction (and projected onto the outer surface of the mask body) is preferably less than the outward height.

The maximum outward extension of the lip, at the junction between the first and second ramp surfaces, is preferably greater than the outward height of the radial outlet.

These conditions are found to contribute to the ability to disrupt the flow.

The length of the first ramp surface is preferably greater than length of the second ramp surface. This means the second ramp surface (back towards the mask body) is steeper than the first ramp surface (away from the mask body).

The flow adjustment element may comprise a removable unit. In this way, a flow against the user may be achieved by removing the flow adjustment element, for example during summer months. It can be installed for winter months (or just cold days) when the flow is to be diverted away from the user.

The invention also provides a mask body for a face mask as defined above, the mask body defining a mask cavity when the mask is worn by a user, comprising:

an outer body having an opening for receiving the fan assembly; and

a flow adjustment element comprising a lip adapted to be positioned downstream of the radial outlet of the fan assembly, for directing the flow from the radial outlet away from the outer body.

This provides a replacement mask body, which may be used with an existing fan assembly, and implement the additional flow adjustment function.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows one example of a mask design to which the invention may be applied;

FIG. 2 shows the design of FIG. 1 in an assembled state from one front side;

FIG. 3 shows the design of FIG. 1 in an assembled state from an opposite front side;

FIG. 4 is used to show the way the components interface with the wearer and shows an alternative design;

FIG. 5 shows how a generic bulge influences a flow;

FIGS. 6A to 6D show examples of how a suitably designed lip influences the flow in such a way as to sufficiently disturb the flow;

FIG. 7 shows shows some design rules for the approach of FIG. 6A;

FIG. 8 shows alternative design rules based on angles;

FIG. 9 shows a front view of the mask incorporating a lip design as shown in FIG. 7;

FIG. 10 shows another view of the mask shown in FIG. 9, and which shows the radial fan outlet more clearly; and

FIG. 11 shows the mask of FIG. 9 in cross section, so the lip can be seen more clearly.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a face mask having a centrifugal fan assembly, with a radial outlet outside the mask cavity. A flow adjusting element is added to prevent outlet flow from the fan assembly traveling along the outside of the mask body and reaching the user, for example at the neck.

The flow adjusting element may be described as a means for disrupting or cancelling the Coanda effect.

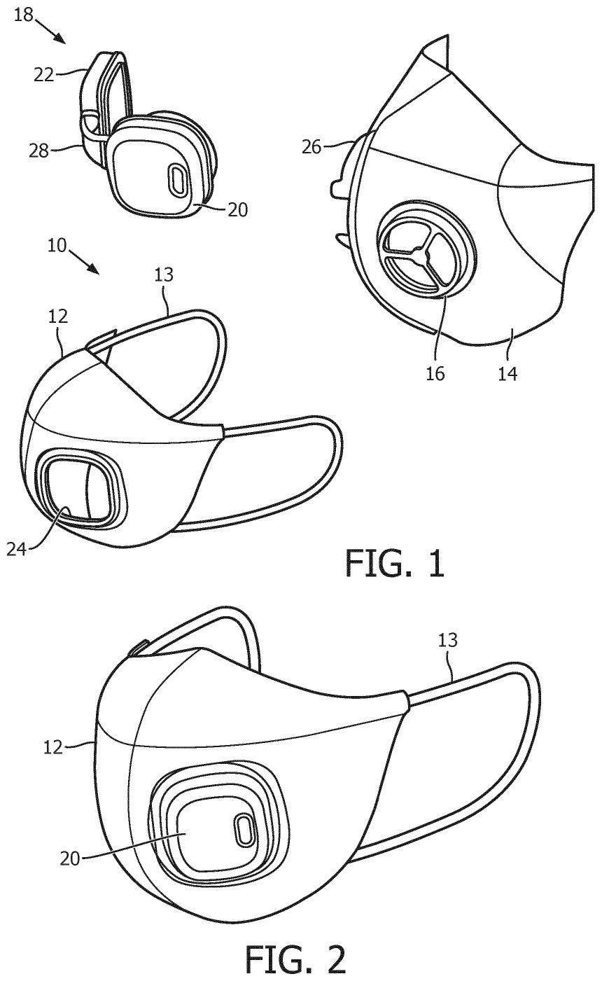

FIG. 1 shows one example of a mask design to which the invention may be applied. The mask 10 is shown in exploded view and comprises an outer casing 12 which functions as a mask body and an inner filter member 14. The outer casing is rigid or semi-rigid with ear straps 13, whereas the filter member 14 is formed of a fabric and thus easily deforms such that an outer edge can match the shape of a wearer's face.

The outer casing is porous so that air can flow through the outer casing.

The inner filter member 14 is sealed around a connector module 16. The connector module 16 is for connecting to a fan module 20. The fan module comprises a centrifugal fan. In this particular example, the connector module 16 comprises a passive check valve. The connector module and the fan module may be considered together to comprise a fan assembly and the two modules may be connected together and disconnected manually.

A control module 18 is coupled to the outside of the filter member 14. The control module includes the fan module 20 of the fan assembly and also a control unit 22. The control unit is inside the outer casing. The control unit 22 for example comprises a battery and other control circuitry. This may include sensors. Note that the control circuitry may instead be on the fan module side and be integrated into the fan module. Thus, the various additional circuitry elements and battery may be divided between the fan module and the control unit in different ways.

The connector module 16 is permanently fixed to the filter member 14 so that it is discarded with the filter member 14 when there is filter replacement. The fan module 20 of the fan assembly is reusable and includes (at least) the fan drive circuitry and fan impeller.

The outer casing 12 has an opening 24 in which the fan module 20 of the fan assembly is received.

An inner surface of the outer casing may also have a receiving dock area for the control unit 22, or else there may be a receiving dock area 26 on the outer surface of the filter member for locating the control unit 22. The control unit may connect to the filter member or to the outer casing by a magnetic coupling as well as, or instead of, a mechanical alignment feature.

An electrical connector bridge 28 provides electrical connection between the control unit 22 and the fan module 20 of the fan assembly, for transfer of power and control signals.

The fan module 20 of the fan assembly and the control unit 22 are at opposite lateral sides of the mask, i.e. one on each side of the nose of the wearer. This provides a balanced weight distribution. By having two modules, the weight of each individual part is reduced, so that the loading at any one location is reduced.

The fan assembly is an exhaust fan. In a most simple design, it operates continuously to provide a continuous supply of air to the face (using air drawn through the mask filter). This provides temperature and humidity control. However, it may be operated in synchronism with the breathing of the wearer (with suitable breath sensing), and it may be controlled bi-directionally. Alternatively, there may be separate inlet and exhaust fans, e.g. one on each lateral side.

All of the various known options for control of the fan may be applied, since this invention relates in particular to control of the outlet flow path from the fan assembly.

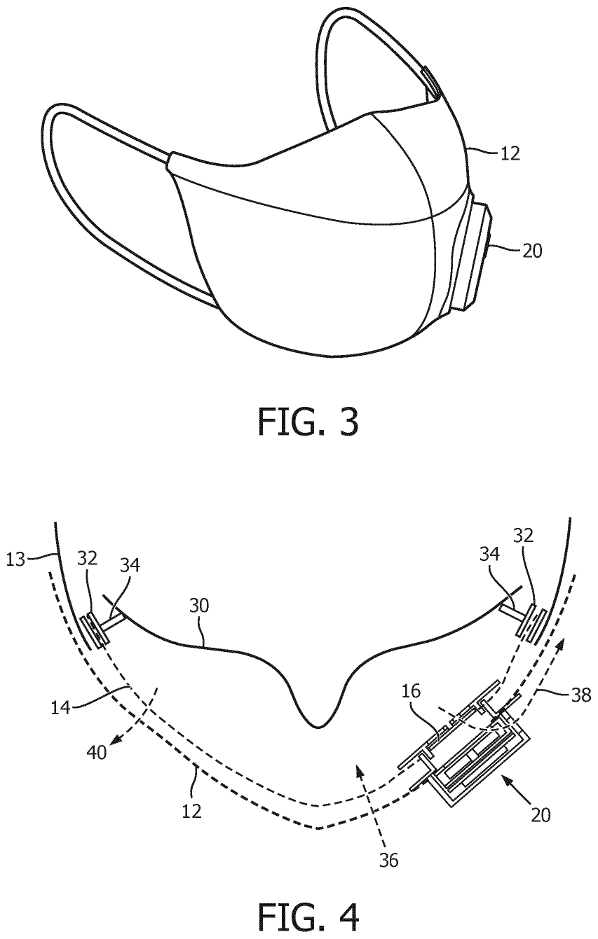

FIG. 2 shows the design of FIG. 1 in an assembled state from one front side and FIG. 3 shows the design of FIG. 1 in an assembled state from an opposite front side.

FIG. 4 is used to show the way the components interface with the wearer and shows an alternative design with a single module. The invention may equally be applied to a single module design. The face 30 of the wearer is shown in cross section from above.

The inner filter member 14 connects to the outer casing 12 with fixings 32. These are for example push fit poppers. An outer periphery of the inner filter member also carries an inwardly projecting seal 34 to form a substantially closed volume between the inner filter member and the face 30.

The module comprises a connector module 16 and a fan module 20 as explained with reference to FIG. 1. The fan module 20 then incorporates the reusable parts of both the fan assembly and the control module.

When breathing in, air is drawn through the inner filter member 14 as shown by arrow 36. The exhaust fan may be operating during this time, providing flow 38, or it may be turned off to save power. When breathing out, the exhaust fan is operating to create flow 38, and there may also be outward flow through the inner filter member as shown by arrow 40. The flow 36 may also continue (depending on how the fan is being operated) but that flow is not breathed in at that time, but instead circulates out through the fan. Breathing comfort is improved particularly because the fan removes the exhaled air from the mask cavity and therefore prevents re-breathing (recycling) of previously exhaled and hence un-fresh air.

The single module may for example comprise a fan, a one-way check valve, a battery and a printed circuit board carrying control circuitry. The fan is on top of the check valve.

In the example of FIG. 4, the connector module 16 and fan module 20 are again separable so that the inner filter member may be replaced (or washed) while reusing the module.

The mask design shown has a V-shape when viewed from above. Thus, it has two opposite lateral sides, and a ridge between the opposite lateral sides.

The fan assembly comprises a centrifugal fan having an axial inlet inside the mask cavity and a radial outlet outside the mask cavity. By “radial outlet” is just meant that the outlet flow is directed outwardly in the plane of rotation of the fan, rather than perpendicular to the plane of rotation. This does not imply that the fan body has a circular shape.

In order for the outlet of the centrifugal fan not to be directly visible, it may face downwardly or backwardly (i.e. back towards the user). This can be seen in FIG. 4, where the flow 38 tracks along the mask body, i.e. the outer casing 12, towards the wearer, for example towards the neck of the wearer.

The invention aims to disrupt this flow so that it departs from the surface of the mask body, and thus is not directed to the neck of the mask wearer.

A first possible approach is to use a lip or bulge to deflect the flow away from the mask body.

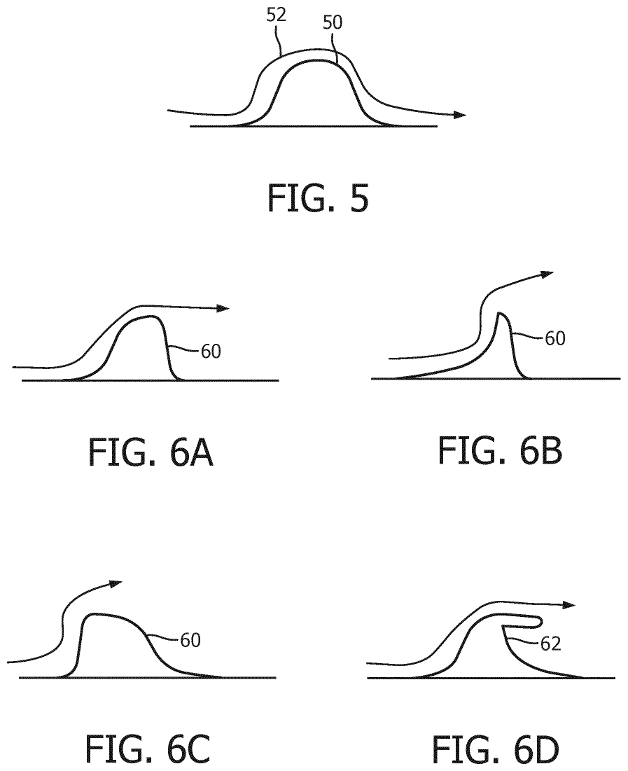

FIG. 5 shows how a generic smooth bulge 50 influences a flow 52. The bulge is for example part of a ridge which is formed where the fan assembly connects to the mask body. In FIG. 5, the flow follows the contour of the bulge surface. Thus, a bulge needs to be designed specifically to disturb the flow sufficiently to disrupt the Coanda effect.

The key parameter for maintaining the Coanda effect is h/r, where h is the flow jet thickness (perpendicular to the surface across which the flow is taking place), and r is the radius of curvature of the surface over which the flow is moving.

For a non-circular path, the local radius will vary along the length of the path. Thus, the minimum radius along the path will define the point where the Coanda effect is most disturbed.

When the local value of h/r reaches a certain limit (which depends on the nature of the flow), the Coanda effect no longer operates.

FIG. 6A shows a first example of how a suitably designed lip 60 influences the flow in such a way as to disturb the flow. The lip has a first slope at the upstream side and a second slope at the downstream side. The lip has a minimum radius of curvature at the apex, and the smaller this radius, the more effective the disruption to the flow. In FIG. 6A, there is a sharp drop at the exit side of the lip. This causes the reduced radius of curvature at the apex.

FIG. 6B shows a second example. The shape of the upstream slope is designed to cause the eventual flow to be directed more outwardly from the underlying surface.

FIG. 6C shows a third example. In FIG. 6C, there is a sharp rise at the entry side of the lip to cause the reduced radius of curvature at the apex. This will introduce more turbulence than the approach of FIG. 6A and hence may create more noise.

FIGS. 6A and 6B, with a steeper exit slope, are preferred to FIG. 6C. A high speed flow gives rise to a reduced pressure, so that surrounding air will be attracted by the pressure differential resulting from that reduced pressure. A steep falling slope encourages air from both sides of the flow to be attracted by the pressure difference, giving more balanced forces and hence a reduced bias towards the surface (i.e. the Coanda effect is reduced).

FIG. 6D shows a fourth example. The lip has an extension piece 62, such that the end of the extension piece defines a tight radius of curvature.

The supporting frame for a fan assembly is typically a streamlined smooth surface, to five a desired aesthetic appearance. To increase the effective value of h/r the four approaches in FIG. 6 are possible. However, these are just examples of possible general shape designs.

It is desired to keep the height of the lip as small as possible and to avoid creating excessive noise. Thus, the design will take into account the dimensions needed to disrupt the flow (for a given outlet flow from the fan assembly), the noise created, and the eventual resulting flow pattern.

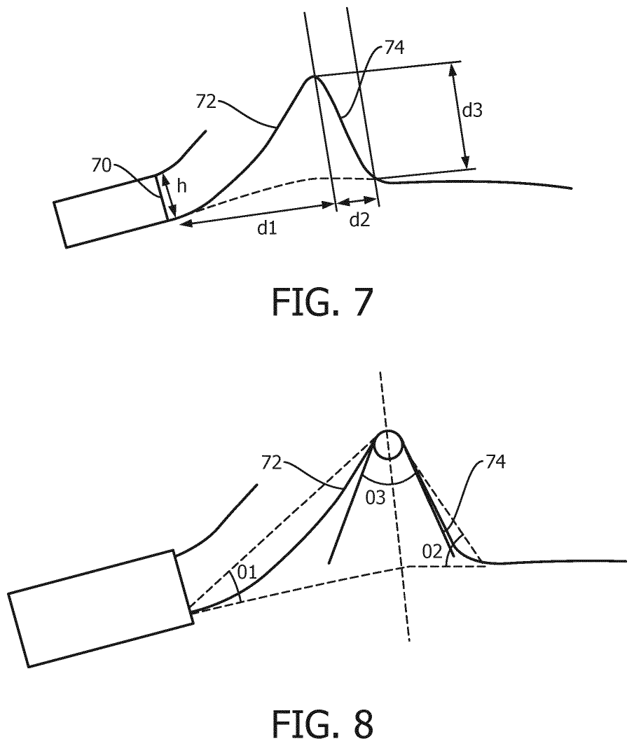

FIG. 7 shows shows some design rules for the approach of FIG. 6A.

The radial fan outlet is defined as having an opening of width h. This “width” may be defined as the outward height of the fan outlet 70, by which is meant the height in a direction perpendicular to the general outer surface of the mask body, i.e. the width of the fan outlet over the mask body.

The lip has a first ramp surface 72 which extends outwardly (i.e. with increasing outward extent) with increasing distance from the radial outlet. In other words, the lip gets higher with increasing distance along the flow direction. At the downstream end, the maximum outward extent is reached, shown as dimension d3.

A second ramp surface 74 is downstream of the first ramp surface 72, and it extends inwardly (i.e. with decreasing outward extent) with increasing distance from the radial outlet. In other words, the lip gets lower with increasing distance along the flow direction. Thus, it tapers back towards the general outer contour of the mask body.

A straight connection from the start of the first ramp surface to the end of the second ramp surface may be considered to be the underlying surface which acts the reference from which the lip height (“outward extent”) is measured.

The ramp surfaces are defined in this way with reference to their shape in a radial plane, i.e. parallel to the radial flow direction and parallel to the axis of rotation of the fan.

The length of the first ramp surface 72 along the radial outlet flow direction and projected onto the underlying surface (i.e. the outer surface of the mask body without the lip) is shown as d1. Thus, d1 is a distance measured along the mask body outer surface beneath the lip.

The length of the second ramp 74 surface along the radial outlet flow direction and again projected onto underlying surface (i.e. the outer surface of the filter member without the lip) is shown as d2.

Desirable conditions to assist in disturbing the Coanda effect are:

d1>h

d3>h

d2<h

It is preferable to maintain d3 as small as possible in order for the lip to have a minimum visual impact.

For example, d3<5 h, or even d3<3 h.

One suitable example is:

d1=5 mm

d2=1.5 mm

d3=3.5 mm

h=2.5 mm

The lip characteristics may instead be defined by slope angles.

FIG. 8 shows the same lip design as FIG. 7. It shows a first straight line from the start of the lip (i.e. the upstream end of the first slope 72) to the apex and a second straight line from the apex to the end of the lip (i.e. the downstream end of the second slope 74).

The angle of inclination of the first straight line is θ1 and the angle of descent of the second straight line is θ2.

θ1<θ2 to give the steeper downstream slope.

The dimensions above correspond to θ1=35 degrees and θ2=67 degrees.

By way of example, and in degrees, 20<θ1<45 and θ2>45. For example θ2<80.

The angle of the slope around the apex is defined as θ3. This is greater than the angle between the straight lines if the actual slopes are concave, as shown.

The radius of curvature around the apex is the minimum radius encountered by the flow. It is approximately 0.7 mm in this example, and is for example in the range 0.5 to 1.5 mm.

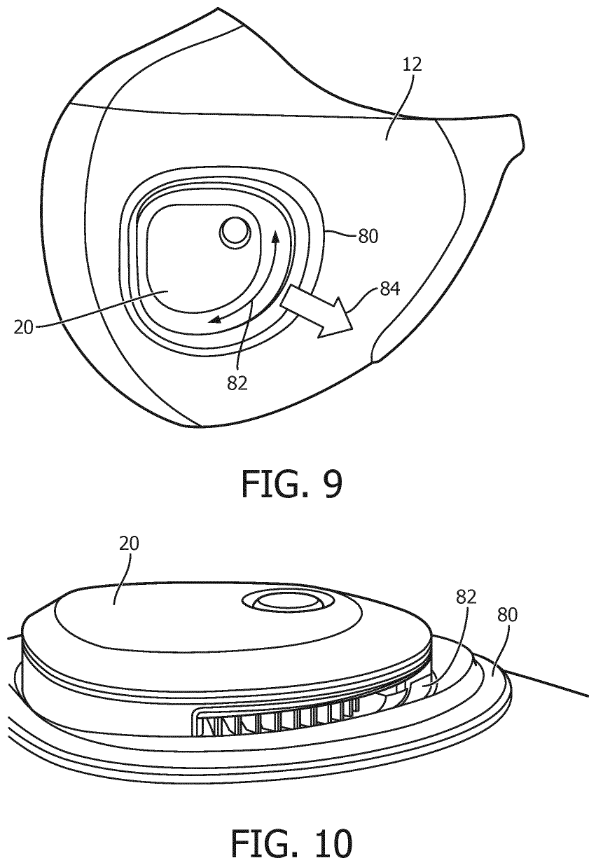

FIG. 9 shows a front view of the mask incorporating a lip design as shown in FIG. 7. The lip 80 may surround the fan assembly 20 or it may only be provided at the radial outlet of the fan assembly. The outlet extends around a region 82. The radially directed flow thus has a general output direction 84 (which may be considered to be the direction of maximum flow rate or an average of the range of radial output directions from the region 82). This output direction has a downward component and a backward component. Generally it is in a direction back towards a bottom lateral area of the region where the mask body interfaces with the face of the user.

This positioning of the outlet means it is not visible from in front and above the mask body, i.e. from the likely position of the eyes of another person.

FIG. 10 shows another view, and which shows the radial fan outlet 82 more clearly.

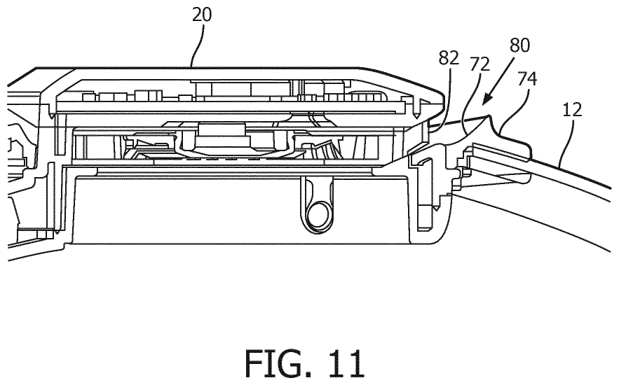

FIG. 11 shows the design in cross section, so the lip 80 with its upstream ramp surface 72 and downstream ramp surface 74 can be seen.

The flow adjustment element is preferably formed as a ring around the opening of the mask body which receives the fan assembly. The lip 80 may be formed all around the ring, even though its function is only needed in the vicinity of the radial outlet of the fan. This may give a symmetrical appearance. Instead, the lip may be formed only around the part of the ring where its flow adjustment function is needed. Thus, the flow adjustment element may be a ring with a lip part and a smooth part without the lip. Finally, the flow adjustment element (and lip) may only be present near the radial outlet of the fan.

In one example, the lip is removable. For example, it may have a shape which fits over the fan assembly 20 and clips into place at the interface between the fan assembly and the mask body. Thus, it may be fitted during cold periods, and removed during hot periods. In this way, the flow can be switched between a flow directed to the user's face or neck for cooling purposes, or a flow directed away from the user's face or neck to avoid excessive cooling.

The lip may instead be a permanent feature.

The lip may be formed as a part of the pump assembly housing, or as part of the mask body or as a separate piece. For example, the lip may be part of the mask body so that a replacement mask body may enable an existing mask (and hence existing fan assembly) to be converted to provide the new flow functionality.

As explained above, the Coanda effect is disrupted based on the value of h/r (the larger the better). The examples above take a given output flow from the fan assembly, i.e. with given value of h, and then insert a feature with suitable effective radius.

The examples above have an outer shell and an inner mask filter. However, the invention may be used for a mask with only a filter layer. In such a case, the filter layer is the mask body. The fan assembly is then attached to the filter layer in the same way as shown above, namely the mask of FIG. 1 does not need the outer cover. Thus, the fan assembly is then mounted on the mask body, namely on the filter layer.

When there is an outer shell, the fan assembly is (additionally) mounted through the outer shell, and the outer shell is then considered to be the mask body.

The mask body is thus the outermost surface of the overall structure, and the flow outlet from the fan is delivered to the outside of this outermost surface. The outer extent of the mask cavity is defined by the filter layer.

When an outer shell or casing is used, the inner filter member may connect to it in any suitable way. Preferably, a push fit connection is used as this allows easy connection and disconnection of the filter member from the outer casing.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. If the term “adapted to” is used in the claims or description, it is noted the term “adapted to” is intended to be equivalent to the term “configured to”. Any reference signs in the claims should not be construed as limiting the scope.

1. A face mask, comprising:
a mask body, wherein a mask cavity is defined inside the mask body when the mask is worn by a user;
a fan assembly mounted on or through the mask body, the fan assembly comprising a centrifugal fan having an axial inlet communicating with the inside of the mask cavity and a radial outlet outside the mask cavity; and
a flow adjustment element comprising a lip downstream of the radial outlet for directing the flow from the radial outlet away from the mask body, wherein the lip has a first ramp surface which extends outwardly with increasing distance from the radial outlet, and a second ramp surface downstream of the first ramp surface, which extends inwardly with increasing distance from the radial outlet.

2. A face mask as claimed in claim 1, wherein the mask body comprises opposite lateral sides which are adapted to face at least partially laterally outwardly when the mask is worn by a user and the fan assembly is mounted at one of the opposite lateral sides.

3. A face mask as claimed in claim 1, comprising a second fan assembly on the opposite lateral side to the fan assembly.

4. A face mask as claimed in claim 1, wherein the mask body comprises a filter member.

5. A face mask as claimed in claim 4, wherein the filter member comprises an opening for receiving the fan assembly.

6. A face mask as claimed in claim 1, wherein the mask body comprises an outer casing, and the face mask further comprises an inner filter member for mounting inside the outer casing.

7. A face mask as claimed in claim 6, wherein the outer casing comprises an opening for receiving the fan assembly.

8. A face mask as claimed in claim 1, wherein the radial outlet is adapted to face at least partially backwardly or at least partially downwardly when the face mask is worn by a user.

9. A face mask as claimed in claim 1, wherein the radial outlet has an outward height (h), and the length (d1) of the first ramp surface along the radial outlet flow direction and projected onto the outer surface of the mask body is greater than the outward height (h).

10. A face mask as claimed in claim 9, wherein the length (d2) of the second ramp surface along the radial outlet flow direction and projected onto the outer surface of the mask body is less than the outward height (h).

11. A face mask as claimed in claim 10, wherein said length (d1) of the first ramp surface is greater than said length (d2) of the second ramp surface

12. A face mask as claimed in claim 9, wherein the maximum outward extension (d3) of the lip, at the junction between the first and second ramp surfaces, is greater than the outward height (h) of the radial outlet.

13. A face mask as claimed in claim 1, wherein the flow adjustment element is a removable unit.

14. A mask body for a face mask as claimed in claim 1, the mask body defining a mask cavity when the mask is worn by a user, comprising:
an outer body having an opening for receiving the fan assembly; and
a flow adjustment element comprising a lip adapted to be positioned downstream of the radial outlet of the fan assembly, for directing the flow from the radial outlet away from the outer body, wherein the lip has a first ramp surface which extends outwardly with increasing distance from the radial outlet, and a second ramp surface downstream of the first ramp surface, which extends inwardly with increasing distance from the radial outlet.
